(19) United States
(12) Patent Application Publication
(10) Pub. No.: US 2014/0203768 A1
(43) Pub. Date: Jul. 24, 2014

(54) SYSTEMS, METHODS, AND APPARATUS RELATED TO INDUCTIVE POWER TRANSFER TRANSMITTER WITH SONIC EMITTER

(71) Applicant: QUALCOMM INCORPORATED, San Diego, CA (US)

(72) Inventors: Peter Andic, Cambridge (UK); Stewart Morley, Cambridge (UK); Traci Charlton-Wells, Cambridge (UK); David T. Berry, Cambridge (UK)

(73) Assignee: QUALCOMM INCORPORATED, San Diego, CA (US)

(21) Appl. No.: 13/745,440

(22) Filed: Jan. 18, 2013

(51) Int. Cl. H02J 7/00

(52) U.S. Cl. CPC H02J 7/00
USPC 320/108

(57) ABSTRACT

This disclosure provides systems, methods and apparatus related to wireless power transmission and living object deterrence. One aspect of the subject matter described in the disclosure provides a method of wireless power transfer. The method includes providing wireless charging power to a receiver. The method further includes activating a living object deterrent. Another aspect of the subject matter described in the disclosure provides a method of wireless power transfer. The method includes providing wireless charging power to a receiver. The method further includes detecting a non-charging object. The method further includes activating a living object deterrent based on said detecting.

### BACKGROUND

1. Field

The present disclosure relates generally to wireless power transfer, and more specifically to devices, systems, and methods related to wireless power transfer to remote systems such as vehicles including batteries and communications therebetween.

2. Background

Remote systems, such as vehicles, have been introduced that include locomotion power derived from electricity received from an energy storage device such as a battery. For example, hybrid electric vehicles include on-board chargers that use power from vehicle braking and traditional motors to charge the vehicles. Vehicles that are solely electric generally receive the electricity for charging the batteries from other sources. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors can sometimes be inconvenient or cumbersome and have other drawbacks. Wireless charging systems that are capable of transferring power in free space (e.g., via a wireless field) to be used to charge electric vehicles can overcome some of the deficiencies of wired charging solutions. As such, wireless charging systems and methods that efficiently and safely transfer power for charging electric vehicles are needed.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

One aspect of the subject matter described in the disclosure provides a method of wireless power transfer. The method includes providing wireless charging power to a receiver. The method further includes activating a living object deterrent.

Another aspect of the subject matter described in the disclosure provides a method of wireless power transfer. The method includes providing wireless charging power to a receiver. The method further includes detecting a non-charging object. The method further includes activating a living object deterrent based on said detecting.

Another aspect of the subject matter described in the disclosure provides a device configured to provide wireless power. The device includes a transmitter configured to provide wireless charging power to a receiver. The device further includes a living object deterrent. The device further includes a controller configured to activate the living object deterrent.

Another aspect of the subject matter described in the disclosure provides a device configured to provide wireless power. The device includes a transmitter configured to provide wireless charging power to a receiver. The device further includes an object detector configured to detect a non-charging object. The device further includes a living object deterrent. The device further includes a controller configured to activate the living object deterrent based on the detection.

Another aspect of the subject matter described in the disclosure provides an apparatus for wireless power transfer. The apparatus includes means for providing wireless charging power to a receiver. The apparatus further includes means for deterring a living object. The apparatus further includes means for activating the living object deterrent.

Another aspect of the subject matter described in the disclosure provides an apparatus for wireless power transfer. The apparatus includes means for providing wireless charging power to a receiver. The apparatus further includes means for detecting a non-charging object. The apparatus further includes means for deterring a living object. The apparatus further includes means for activating a living object deterrent based on said detecting.

Another aspect of the subject matter described in the disclosure provides a non-transitory computer-readable medium including code that, when executed, causes an apparatus to provide wireless charging power to a receiver. The medium further includes code that, when executed, causes the apparatus to activate a living object deterrent.

Another aspect of the subject matter described in the disclosure provides a non-transitory computer-readable medium including code that, when executed, causes an apparatus to provide wireless charging power to a receiver. The medium further includes code that, when executed, causes the apparatus to detect a non-charging object. The medium further includes code that, when executed, causes the apparatus to activate a living object deterrent based on said detecting.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates a diagram of an exemplary wireless power transfer system for charging an electric vehicle, in accordance with an exemplary embodiment of the invention.

FIG. 2 illustrates a schematic diagram of exemplary core components of the wireless power transfer system of FIG. 1.

FIG. 3 illustrates another functional block diagram showing exemplary core and ancillary components of the wireless power transfer system of FIG. 1.

FIG. 4 illustrates a functional block diagram showing a replaceable contactless battery disposed in an electric vehicle, in accordance with an exemplary embodiment of the invention.

FIGS. 5A, 5B, 5C, and 5D are diagrams of exemplary configurations for the placement of an induction coil and ferrite material relative to a battery, in accordance with exemplary embodiments of the invention.

FIG. 6 is a chart of a frequency spectrum showing exemplary frequencies that can be available for wireless charging an electric vehicle, in accordance with an exemplary embodiment of the invention.

FIG. 7 is a chart showing exemplary frequencies and transmission distances that can be useful in wireless charging electric vehicles, in accordance with an exemplary embodiment of the invention.

FIG. 8 illustrates a flowchart of an exemplary method of wireless power transfer.

FIG. 9 is a functional block diagram of a wireless power apparatus 900, in accordance with an exemplary embodiment of the invention.

FIG. 10 illustrates a flowchart of an exemplary method of wireless power transfer.

FIG. 11 is a functional block diagram of a wireless power apparatus, in accordance with an exemplary embodiment of the invention.

The various features illustrated in the drawings may not be drawn to scale. Accordingly, the dimensions of the various features can be arbitrarily expanded or reduced for clarity. In addition, some of the drawings may not depict all of the components of a given system, method or device. Finally, like reference numerals can be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

Wirelessly transferring power can refer to transferring any form of energy associated with electric fields, magnetic fields, electromagnetic fields, or otherwise from a transmitter to a receiver without the use of physical electrical conductors (e.g., power can be transferred through free space). The power output into a wireless field (e.g., a magnetic field) can be received, captured by, or coupled by a “receiving coil” to achieve power transfer.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles can be hybrid electric vehicles that include besides electric motors, a traditional combustion engine for direct locomotion or to charge the vehicle's battery. Other electric vehicles can draw all locomotion ability from electrical power. An electric vehicle is not limited to an automobile and can include motorcycles, carts, scooters, and the like. By way of example and not limitation, a remote system is described herein in the form of an electric vehicle (EV). Furthermore, other remote systems that can be at least partially powered using a chargeable energy storage device are also contemplated (e.g., electronic devices such as personal computing devices and the like).

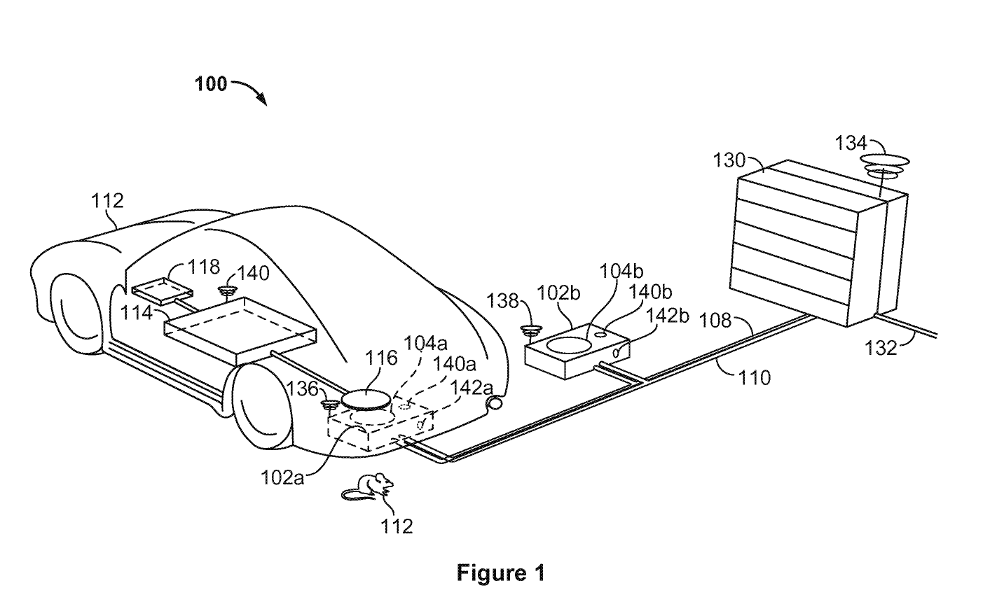

FIG. 1 is a diagram of an exemplary wireless power transfer system 100 for charging an electric vehicle 112, in accordance with an exemplary embodiment of the invention. The wireless power transfer system 100 enables charging of an electric vehicle 112 while the electric vehicle 112 is parked near a base wireless charging system 102a. Spaces for two electric vehicles are illustrated in a parking area to be parked over corresponding base wireless charging system 102a and 102b. In some embodiments, a local distribution center 130 can be connected to a power backbone 132 and configured to provide an alternating current (AC) or a direct current (DC) supply through a power link 110 to the base wireless charging system 102a. The base wireless charging system 102a includes a base system induction coil 104a for wirelessly transferring or receiving power, an antenna 136, a living object deterrent 140a, and an object detector 142a. The base wireless charging system 102b includes a base system induction coil 104b for wirelessly transferring or receiving power, an antenna 138, a living object deterrent 140b, and an object detector 142b. An electric vehicle 112 can include a battery unit 118, an electric vehicle induction coil 116, an electric vehicle wireless charging system 114, and an antenna 140. The electric vehicle induction coil 116 can interact with the base system induction coil 104a for example, via a region of the electromagnetic field generated by the base system induction coil 104a.

In some exemplary embodiments, the electric vehicle induction coil 116 can receive power when the electric vehicle induction coil 116 is located in an energy field produced by the base system induction coil 104a. The field corresponds to a region where energy output by the base system induction coil 104a can be captured by an electric vehicle induction coil 116. For example, the energy output by the base system induction coil 104a can be at a level sufficient to charge or power the electric vehicle 112 (e.g., to charge the battery unit 118). In some cases, the field can correspond to the “near field” of the base system induction coil 104a. The near-field can correspond to a region in which there are strong reactive fields resulting from the currents and charges in the base system induction coil 104a that do not radiate power away from the base system induction coil 104a. In some cases the near-field can correspond to a region that is within about ½π of wavelength of the base system induction coil 104a (and vice versa for the electric vehicle induction coil 116) as will be further described below.

Local distribution center 130 can be configured to communicate with external sources (e.g., a power grid) via a communication backhaul 134, and with the base wireless charging system 102a via a communication link 108.

Base wireless charging systems 102a and 102b can be configured to communicate with the electric vehicle wireless charging system 114 via antennas 136 and 138. For example, the wireless charging system 102a can communicate with the electric vehicle wireless charging system 114 using a communication channel between antennas 138 and 140. The communication channels can be any type of communication channels such as, for example, Bluetooth, zigbee, cellular, wireless local area network (WLAN), etc.

In some embodiments the electric vehicle induction coil 116 can be aligned with the base system induction coil 104a and, therefore, disposed within a near-field region simply by the driver positioning the electric vehicle 112 correctly relative to the base system induction coil 104a. In other embodiments, the driver can be given visual feedback, auditory feedback, or combinations thereof to determine when the electric vehicle 112 is properly placed for wireless power transfer. In yet other embodiments, the electric vehicle 112 can be positioned by an autopilot system, which can move the electric vehicle 112 back and forth (e.g., in zig-zag movements) until an alignment error has reached a tolerable value. This can be performed automatically and autonomously by the electric vehicle 112 without or with only minimal driver intervention provided that the electric vehicle 112 is equipped with a servo steering wheel, ultrasonic sensors, and intelligence to adjust the vehicle. In still other embodiments, the electric vehicle induction coil 116, the base system induction coil 104a, or a combination thereof can have functionality for displacing and moving the induction coils 116 and 104a relative to each other to more accurately orient them and develop more efficient coupling therebetween.

The base wireless charging system 102a can be located in a variety of locations. As non-limiting examples, some suitable locations include a parking area at a home of the electric vehicle 112 owner, parking areas reserved for electric vehicle wireless charging modeled after conventional petroleum-based filling stations, and parking lots at other locations such as shopping centers and places of employment.

Charging electric vehicles wirelessly can provide numerous benefits. For example, charging can be performed automatically, virtually without driver intervention and manipulations thereby improving convenience to a user. There can also be no exposed electrical contacts and no mechanical wear out, thereby improving reliability of the wireless power transfer system 100. Manipulations with cables and connectors may not be needed, and there can be no cables, plugs, or sockets that can be exposed to moisture and water in an outdoor environment, thereby improving safety. There can also be no sockets, cables, and plugs visible or accessible, thereby reducing potential vandalism of power charging devices. Further, since an electric vehicle 112 can be used as distributed storage devices to stabilize a power grid, a docking-to-grid solution can be used to increase availability of vehicles for Vehicle-to-Grid (V2G) operation.

A wireless power transfer system 100 as described with reference to FIG. 1 can also provide aesthetical and non-impedimental advantages. For example, there can be no charge columns and cables that can be impedimental for vehicles and/or pedestrians.

As a further explanation of the vehicle-to-grid capability, the wireless power transmit and receive capabilities can be configured to be reciprocal such that the base wireless charging system 102a transfers power to the electric vehicle 112 and the electric vehicle 112 transfers power to the base wireless charging system 102a e.g., in times of energy shortfall. This capability can be useful to stabilize the power distribution grid by allowing electric vehicles to contribute power to the overall distribution system in times of energy shortfall caused by over demand or shortfall in renewable energy production (e.g., wind or solar).

In some exemplary embodiments, there can be regulations limiting the amount of power that the base pad 102a can transmit at a specific frequency. In some cases, these regulations are meant to protect living objects such as humans or animals (for example, a cat, a dog, or a mouse 112) from electromagnetic radiation. In some embodiments, the area around the induction coils 140a and 140b can become dangerously warm. Accordingly, it can be desirable to alert and/or deter living objects from locating in the vicinity of the base wireless charging systems 102a and 102b.

In an embodiment, the living object deterrents 140a and 140b serve to alert and/or repel a living object in the vicinity of the base wireless charging systems 102a and 102b. For example, the living object deterrents 140a and 140b can include one or more of a sonic emitter and flashing or continuous lights. A sonic emitter can be configured to emit sounds human audible frequencies, ultrasonic frequencies, and/or subsonic frequencies. For example, the living object deterrent 140a can be configured to emit sounds that are outside the range of human hearing, but are audible to animals. The sonic emitter can include a speaker, piezoelectric transducer, or any other means of generating sound. In an embodiment, the living object deterrents 140a and 140b can be configured to generate sound via magnetic resonance, in some embodiments in conjunction with the induction coils 104a and 104b.

In various embodiments, the object detectors 142a and 142b detect a nearby object. The nearby object can include an intended receiver, a device to be charged, and/or a foreign object. A foreign object can be something other than an intended transmission target (i.e. a non-charging device) such as, for example, a parasitic receiver, an inorganic object, or a living object (such as a human, animal, etc.). A parasitic receiver can include, for example, a non-electronic metallic object, an unauthorized chargeable device, etc.

In various embodiments, the object detectors 142a and 142b can detect the presence of a nearby object based on a line-of-sight detection mechanism. Line-of-sight detection mechanisms can include for example, infrared detection, ultrasonic detection, radar detection, laser detection, camera-based detection, etc. In the object detectors 142a and 142b can implement computer vision techniques using data from any combination of sources discussed herein, and can include depth information (for example, using stereoscopic techniques). In some embodiments, it can be preferable to use a non-line-of-sight detection mechanism. Non-line-of-sight mechanisms can include, for example, capacitive detection, radiometric detection, detection of changes in an inductive coupling characteristic, etc.

In an embodiment, the object detectors 142a and 142b can be configured to distinguish between living and non-living objects, and/or between different categories of non-living objects (e.g., humans, animals, insects, etc.). In various embodiments, the object detectors 142a and 142b can determine a characteristic of a detected object (e.g., living, non-living, large animal, small animal, etc.) using object recognition techniques such as pattern matching, machine learning, etc. In some embodiments, object characterization can take place remotely. For example, the object detectors 142 and 142b can be configured to transmit raw or processed sensor data to a remote server (not shown), which can be configured to detect objects and/or characterize detected objects. In an embodiment, an infrared or heat sensor can be used to distinguish living from non-living objects, either alone or in combination with any of the aforementioned detection mechanisms, for example using a threshold and/or calibrated heat metric.

In various embodiments, the base wireless charging systems 102a and 102b can vary a wireless power transmission based on detection of a nearby object. The nearby object can include an intended receiver, a device to be charged, and/or a foreign object. A foreign object can be something other than an intended transmission target (i.e. a non-charging device) such as, for example, a parasitic receiver, an inorganic object, or a living object (such as a human, animal, etc.). A parasitic receiver can include, for example, a non-electronic metallic object, an unauthorized chargeable device, etc.

For example, when object detectors 142a and 142b detect a foreign object and/or living object, the base wireless charging systems 102a and 102b can reduce a transmit power or shut down power transfer entirely. The base wireless charging systems 102a and 102b can activate the living object deterrents 140a and 140b configured to alert and/or repel a living object in the vicinity of the base wireless charging systems 102a and 102b.

The base wireless charging systems 102a and 102b can periodically, intermittently, or continuously check to determine whether the foreign object is still in the vicinity of the base wireless charging systems 102a and 102b. When the foreign object is no longer in the vicinity, the system can increase the transmit power, or reinitiate wireless power transfer. When the foreign object is no longer in the vicinity, the base wireless charging systems 102a and 102b can deactivate the living object deterrents 140a and 140b. In some embodiments, the base wireless charging systems 102a and 102b may not deactivate living object deterrents 140a and 140b immediately, and can wait a predetermined or dynamically determined amount of time before deactivating the living object deterrents 140a and 140b.

In various embodiments, the living object deterrents 140a and 140b can activate intermittently, periodically, or continuously during charging, regardless of detection of a foreign object. Accordingly, some embodiments can omit the object detectors 142a and 142b. The base wireless charging systems 102a and 102b can activate living object deterrents 140a and 140b prior to initiating wireless power transmission. For example, the base wireless charging systems 102a and 102b can activate the living object deterrents 140a and 140b for a predetermined amount of time before initiating wireless power transmission.

As discussed above, the object detectors 142a and 142b can distinguish between non-living objects and living objects, and may only activate the living object deterrents 140a and 140b in the presence of living objects. For example, the object detectors 142a and 142b detect non-living objects, the base wireless charging systems 102a and 102b can reduce or terminate power transmission without activating the living object deterrents 140a and 140b. In various embodiments, the living object deterrents 140a and 140b and/or the object detectors 142a and 142b can be located in another location such as, for example, on the electric vehicle 112, or elsewhere.

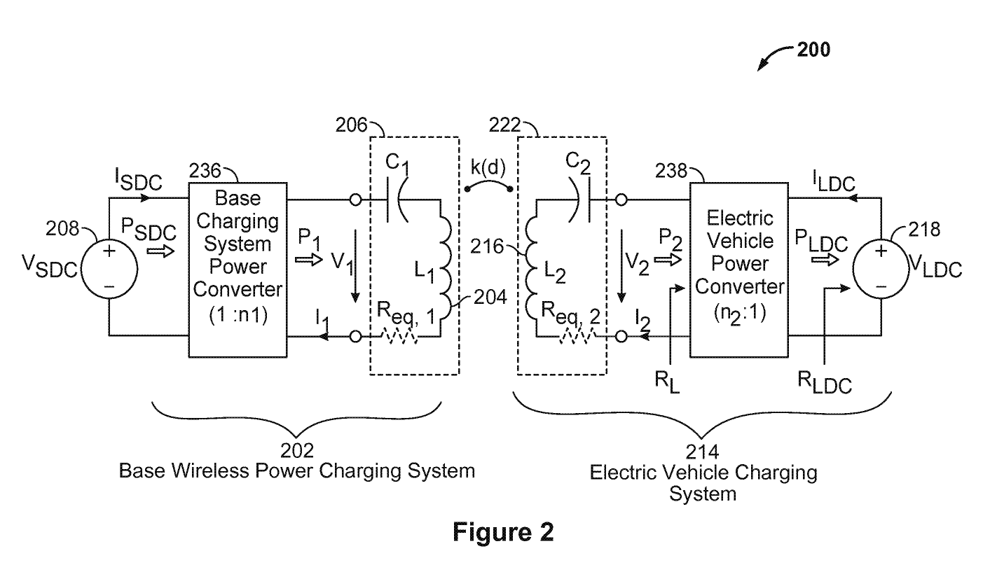

FIG. 2 is a schematic diagram of exemplary components of the wireless power transfer system 100 of FIG. 1. As shown in FIG. 2, the wireless power transfer system 200 can include a base system transmit circuit 206 including a base system induction coil 204 having an inductance L₁. The wireless power transfer system 200 further includes an electric vehicle receive circuit 222 including an electric vehicle induction coil 216 having an inductance L₂. Embodiments described herein can use capacitively loaded wire loops (i.e., multi-turn coils) forming a resonant structure that is capable of efficiently coupling energy from a primary structure (transmitter) to a secondary structure (receiver) via a magnetic or electromagnetic near field if both primary and secondary are tuned to a common resonant frequency. The coils can be used for the electric vehicle induction coil 216 and the base system induction coil 204. Using resonant structures for coupling energy can be referred to “magnetic coupled resonance,” “electromagnetic coupled resonance,” and/or “resonant induction.” The operation of the wireless power transfer system 200 will be described based on power transfer from a base wireless power charging system 202 to an electric vehicle 112, but is not limited thereto. For example, as discussed above, the electric vehicle 112 can transfer power to the base wireless charging system 102a.

With reference to FIG. 2, a power supply 208 (e.g., AC or DC) supplies power P_{SDC} to the base wireless power charging system 202 to transfer energy to an electric vehicle 112. The base wireless power charging system 202 includes a base charging system power converter 236. The base charging system power converter 236 can include circuitry such as an AC/DC converter configured to convert power from standard mains AC to DC power at a suitable voltage level, and a DC/low frequency (LF) converter configured to convert DC power to power at an operating frequency suitable for wireless high power transfer. The base charging system power converter 236 supplies power P₁ to the base system transmit circuit 206 including the capacitor C₁ in series with the base system induction coil 204 to emit an electromagnetic field at a desired frequency. The capacitor C₁ can be provided to form a resonant circuit with the base system induction coil 204 that resonates at a desired frequency. The base system induction coil 204 receives the power P₁ and wirelessly transmits power at a level sufficient to charge or power the electric vehicle 112. For example, the power level provided wirelessly by the base system induction coil 204 can be on the order of kilowatts (kW) (e.g., anywhere from 1 kW to 110 kW or higher or lower).

The base system transmit circuit 206 including the base system induction coil 204 and electric vehicle receive circuit 222 including the electric vehicle induction coil 216 can be tuned to substantially the same frequencies and can be positioned within the near-field of an electromagnetic field transmitted by one of the base system induction coil 204 and the electric vehicle induction coil 116. In this case, the base system induction coil 204 and electric vehicle induction coil 116 can become coupled to one another such that power can be transferred to the electric vehicle receive circuit 222 including capacitor C₂ and electric vehicle induction coil 116. The capacitor C₂ can be provided to form a resonant circuit with the electric vehicle induction coil 216 that resonates at a desired frequency. Element k(d) represents the mutual coupling coefficient resulting at coil separation. Equivalent resistances R_{eq.1} and R_{eq.2} represent the losses that can be inherent to the induction coils 204 and 216 and the anti-reactance capacitors C₁ and C₂. The electric vehicle receive circuit 222 including the electric vehicle induction coil 316 and capacitor C₂ receives power P₂ and provides the power P₂ to an electric vehicle power converter 238 of an electric vehicle charging system 214.

The electric vehicle power converter 238 can include, among other things, a LF/DC converter configured to convert power at an operating frequency back to DC power at a voltage level matched to the voltage level of an electric vehicle battery unit 218. The electric vehicle power converter 238 can provide the converted power P_{LDC} to charge the electric vehicle battery unit 218. The power supply 208, base charging system power converter 236, and base system induction coil 204 can be stationary and located at a variety of locations as discussed above. The battery unit 218, electric vehicle power converter 238, and electric vehicle induction coil 216 can be included in an electric vehicle charging system 214 that is part of electric vehicle 112 or part of the battery pack (not shown). The electric vehicle charging system 214 can also be configured to provide power wirelessly through the electric vehicle induction coil 216 to the base wireless power charging system 202 to feed power back to the grid. Each of the electric vehicle induction coil 216 and the base system induction coil 204 can act as transmit or receive induction coils based on the mode of operation.

While not shown, the wireless power transfer system 200 can include a load disconnect unit (LDU) to safely disconnect the electric vehicle battery unit 218 or the power supply 208 from the wireless power transfer system 200. For example, in case of an emergency or system failure, the LDU can be triggered to disconnect the load from the wireless power transfer system 200. The LDU can be provided in addition to a battery management system for managing charging to a battery, or it can be part of the battery management system.

Further, the electric vehicle charging system 214 can include switching circuitry (not shown) for selectively connecting and disconnecting the electric vehicle induction coil 216 to the electric vehicle power converter 238. Disconnecting the electric vehicle induction coil 216 can suspend charging and also can adjust the “load” as “seen” by the base wireless charging system 102a (acting as a transmitter), which can be used to “cloak” the electric vehicle charging system 114 (acting as the receiver) from the base wireless charging system 102a. The load changes can be detected if the transmitter includes the load sensing circuit. Accordingly, the transmitter, such as a base wireless charging system 202, can have a mechanism for determining when receivers, such as an electric vehicle charging system 114, are present in the near-field of the base system induction coil 204.

As described above, in operation, assuming energy transfer towards the vehicle or battery, input power is provided from the power supply 208 such that the base system induction coil 204 generates a field for providing the energy transfer. The electric vehicle induction coil 216 couples to the radiated field and generates output power for storage or consumption by the electric vehicle 112. As described above, in some embodiments, the base system induction coil 204 and electric vehicle induction coil 116 are configured according to a mutual resonant relationship such that the resonant frequency of the electric vehicle induction coil 116 and the resonant frequency of the base system induction coil 204 are very close or substantially the same. Transmission losses between the base wireless power charging system 202 and electric vehicle charging system 214 are minimal when the electric vehicle induction coil 216 is located in the near-field of the base system induction coil 204.

As stated, an efficient energy transfer occurs by coupling a large portion of the energy in the near field of a transmitting induction coil to a receiving induction coil rather than propagating most of the energy in an electromagnetic wave to the far-field. When in the near field, a coupling mode can be established between the transmit induction coil and the receive induction coil. The area around the induction coils where this near field coupling can occur is referred to herein as a near field coupling mode region.

While not shown, the base charging system power converter 236 and the electric vehicle power converter 238 can both include an oscillator, a driver circuit such as a power amplifier, a filter, and a matching circuit for efficient coupling with the wireless power induction coil. The oscillator can be configured to generate a desired frequency, which can be adjusted in response to an adjustment signal. The oscillator signal can be amplified by a power amplifier with an amplification amount responsive to control signals. The filter and matching circuit can be included to filter out harmonics or other unwanted frequencies and match the impedance of the power conversion module to the wireless power induction coil. The power converters 236 and 238 can also include a rectifier and switching circuitry to generate a suitable power output to charge the battery.

The electric vehicle induction coil 216 and base system induction coil 204 as described throughout the disclosed embodiments can be referred to or configured as “loop” antennas, and more specifically, multi-turn loop antennas. The induction coils 204 and 216 can also be referred to herein or be configured as “magnetic” antennas. The term “coils” is intended to refer to a component that can wirelessly output or receive energy four coupling to another “coil.” The coil can also be referred to as an “antenna” of a type that is configured to wirelessly output or receive power. As used herein, coils 204 and 216 are examples of “power transfer components” of a type that are configured to wirelessly output, wirelessly receive, and/or wirelessly relay power. Loop (e.g., multi-turn loop) antennas can be configured to include an air core or a physical core such as a ferrite core. An air core loop antenna can allow the placement of other components within the core area. Physical core antennas including ferromagnetic or ferromagnetic materials can allow development of a stronger electromagnetic field and improved coupling.

As discussed above, efficient transfer of energy between a transmitter and receiver occurs during matched or nearly matched resonance between a transmitter and a receiver. However, even when resonance between a transmitter and receiver are not matched, energy can be transferred at a lower efficiency. Transfer of energy occurs by coupling energy from the near field of the transmitting induction coil to the receiving induction coil residing within a region (e.g., within a predetermined frequency range of the resonant frequency, or within a predetermined distance of the near-field region) where this near field is established rather than propagating the energy from the transmitting induction coil into free space.

A resonant frequency can be based on the inductance and capacitance of a transmit circuit including an induction coil (e.g., the base system induction coil 204) as described above. As shown in FIG. 2, inductance can generally be the inductance of the induction coil, whereas, capacitance can be added to the induction coil to create a resonant structure at a desired resonant frequency. As a non-limiting example, as shown in FIG. 2, a capacitor can be added in series with the induction coil to create a resonant circuit (e.g., the base system transmit circuit 206) that generates an electromagnetic field. Accordingly, for larger diameter induction coils, the value of capacitance needed to induce resonance can decrease as the diameter or inductance of the coil increases. Inductance can also depend on a number of turns of an induction coil. Furthermore, as the diameter of the induction coil increases, the efficient energy transfer area of the near field can increase. Other resonant circuits are possible. As another non limiting example, a capacitor can be placed in parallel between the two terminals of the induction coil (e.g., a parallel resonant circuit). Furthermore an induction coil can be designed to have a high quality (Q) factor to improve the resonance of the induction coil. For example, the Q factor can be 300 or greater.

As described above, according to some embodiments, coupling power between two induction coils that are in the near field of one another is disclosed. As described above, the near field can correspond to a region around the induction coil in which electromagnetic fields exist but may not propagate or radiate away from the induction coil. Near-field coupling-mode regions can correspond to a volume that is near the physical volume of the induction coil, typically within a small fraction of the wavelength. According to some embodiments, electromagnetic induction coils, such as single and multi turn loop antennas, are used for both transmitting and receiving since magnetic near field amplitudes in practical embodiments tend to be higher for magnetic type coils in comparison to the electric near fields of an electric type antenna (e.g., a small dipole). This allows for potentially higher coupling between the pair. Furthermore, “electric” antennas (e.g., dipoles and monopoles) or a combination of magnetic and electric antennas can be used.

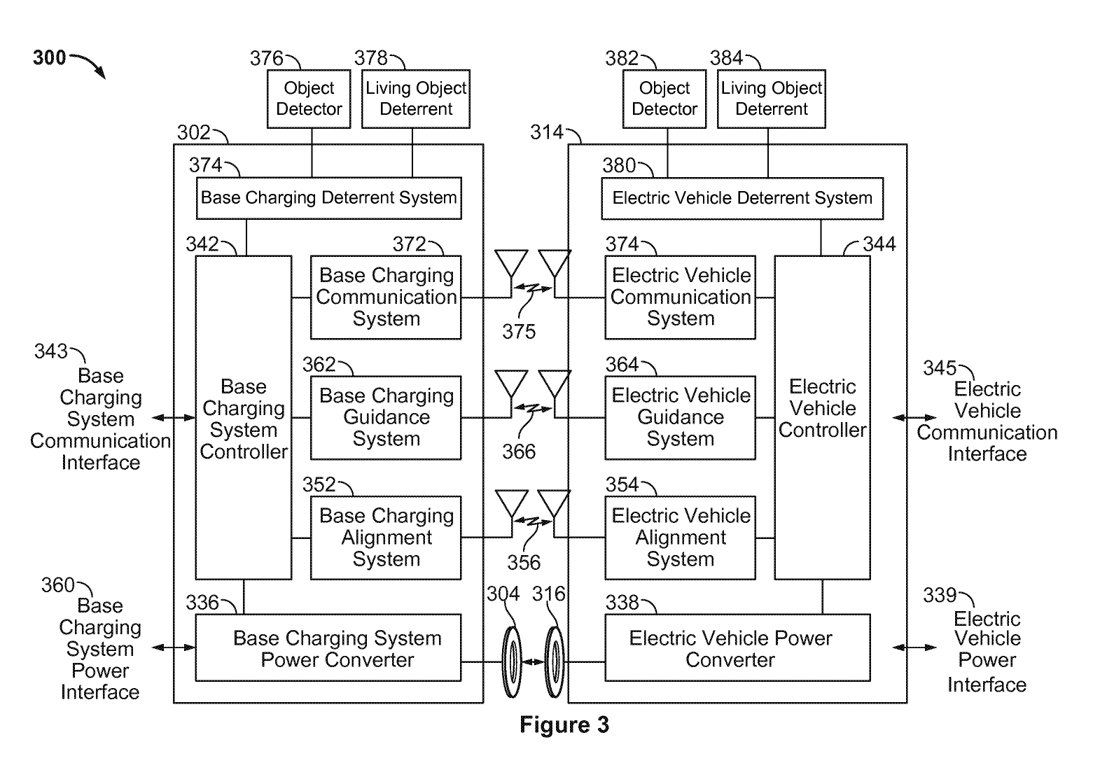

FIG. 3 is another functional block diagram showing exemplary core and ancillary components of the wireless power transfer system 300 of FIG. 1. The wireless power transfer system 300 illustrates a communication link 375, a guidance link 366, and alignment systems 352, 354 for the base system induction coil 304 and electric vehicle induction coil 316. As described above with reference to FIG. 2, and assuming energy flow towards the electric vehicle 112, in FIG. 3 a base charging system power interface 360 can be configured to provide power to a charging system power converter 336 from a power source, such as an AC or DC power supply through the local distribution center 130 (FIG. 1). The base charging system power converter 336 can receive AC or DC power from the base charging system power interface 360 to excite the base system induction coil 304 at or near its resonant frequency. The electric vehicle induction coil 316, when in the near field coupling-mode region, can receive energy from the near field coupling mode region to oscillate at or near the resonant frequency. The electric vehicle power converter 338 converts the oscillating signal from the electric vehicle induction coil 316 to a power signal suitable for charging a battery via the electric vehicle power interface 339.

The base wireless charging system 302 includes a base charging system controller 342 and the electric vehicle charging system 314 includes an electric vehicle controller 344. The base charging system controller 342 can include a base charging system communication interface 343 to other systems (not shown) such as, for example, a computer, a wireless device, and a power distribution center, or a smart power grid. The electric vehicle controller 344 can include an electric vehicle communication interface 345 to other systems (not shown) such as, for example, an on-board computer on the vehicle, other battery charging controller, other electronic systems within the vehicles, and remote electronic systems.

The base charging system controller 342 and electric vehicle controller 344 can include subsystems or modules for specific application with separate communication channels. These communications channels can be separate physical channels or separate logical channels. As non-limiting examples, a base charging alignment system 352 can communicate with an electric vehicle alignment system 354 through a communication link 356 to provide a feedback mechanism for more closely aligning the base system induction coil 304 and electric vehicle induction coil 316, either autonomously or with operator assistance. Similarly, a base charging guidance system 362 can communicate with an electric vehicle guidance system 364 through a guidance link 366 to provide a feedback mechanism to guide an operator in aligning the base system induction coil 304 and electric vehicle induction coil 316. In addition, there can be separate general-purpose communication links (e.g., channels), such as communication link 375, supported by base charging communication system 372 and electric vehicle communication system 374 for communicating other information between the base wireless power charging system 302 and the electric vehicle charging system 314. This information can include information about electric vehicle characteristics, battery characteristics, charging status, and power capabilities of both the base wireless power charging system 302 and the electric vehicle charging system 314, as well as maintenance and diagnostic data for the electric vehicle 112. These communication links or channels can be separate physical communication channels such as, for example, Bluetooth, zigbee, cellular, etc.

Electric vehicle controller 344 can also include a battery management system (BMS) (not shown) that manages charge and discharge of the electric vehicle principal battery, a parking assistance system based on microwave or ultrasonic radar principles, a brake system configured to perform a semi-automatic parking operation, and a steering wheel servo system configured to assist with a largely automated parking ‘park by wire’ that can provide higher parking accuracy, thus reducing the need for mechanical horizontal induction coil alignment in any of the base wireless charging system 102a and the electric vehicle charging system 114. Further, electric vehicle controller 344 can be configured to communicate with electronics of the electric vehicle 112. For example, electric vehicle controller 344 can be configured to communicate with visual output devices (e.g., a dashboard display), acoustic/audio output devices (e.g., buzzer, speakers), mechanical input devices (e.g., keyboard, touch screen, and pointing devices such as joystick, trackball, etc.), and audio input devices (e.g., microphone with electronic voice recognition).

Furthermore, the wireless power transfer system 300 can include detection and sensor systems. For example, the wireless power transfer system 300 can include sensors for use with systems to properly guide the driver or the vehicle to the charging spot, sensors to mutually align the induction coils with the required separation/coupling, sensors to detect objects that can obstruct the electric vehicle induction coil 316 from moving to a particular height and/or position to achieve coupling, and safety sensors for use with systems to perform a reliable, damage free, and safe operation of the system. For example, a safety sensor can include the object detectors 376 and/or 382 (described in greater detail below), which can include one or more of: a sensor for detection of presence of animals or children approaching the wireless power induction coils 104a, 116 beyond a safety radius, detection of metal objects near the base system induction coil 304 that can be heated up (induction heating), detection of hazardous events such as incandescent objects on the base system induction coil 304, and temperature monitoring of the base wireless power charging system 302 and electric vehicle charging system 314 components.

The wireless power transfer system 300 can also support plug-in charging via a wired connection. A wired charge port can integrate the outputs of the two different chargers prior to transferring power to or from the electric vehicle 112. Switching circuits can provide the functionality as needed to support both wireless charging and charging via a wired charge port.

To communicate between a base wireless charging system 302 and an electric vehicle charging system 314, the wireless power transfer system 300 can use both in-band signaling and an RF data modem (e.g., Ethernet over radio in an unlicensed band). The out-of-band communication can provide sufficient bandwidth for the allocation of value-added services to the vehicle user/owner. A low depth amplitude or phase modulation of the wireless power carrier can serve as an in-band signaling system with minimal interference.

In addition, some communication can be performed via the wireless power link without using specific communications antennas. For example, the wireless power induction coils 304 and 316 can also be configured to act as wireless communication transmitters. Thus, some embodiments of the base wireless power charging system 302 can include a controller (not shown) for enabling keying type protocol on the wireless power path. By keying the transmit power level (amplitude shift keying) at predefined intervals with a predefined protocol, the receiver can detect a serial communication from the transmitter. The base charging system power converter 336 can include a load sensing circuit (not shown) for detecting the presence or absence of active electric vehicle receivers in the vicinity of the near field generated by the base system induction coil 304. By way of example, a load sensing circuit monitors the current flowing to the power amplifier, which is affected by the presence or absence of active receivers in the vicinity of the near field generated by base system induction coil 104a. Detection of changes to the loading on the power amplifier can be monitored by the base charging system controller 342 for use in determining whether to enable the oscillator for transmitting energy, to communicate with an active receiver, or a combination thereof.

To enable wireless high power transfer, some embodiments can be configured to transfer power at a frequency in the range from 10-60 kHz. This low frequency coupling can allow highly efficient power conversion that can be achieved using solid state devices. In addition, there can be less coexistence issues with radio systems compared to other bands.

In some embodiments, the base wireless power charging system 302 includes a base charging deterrent system 374. The base charging deterrent system 374 can be configured to detect a living object, adjust a wireless power transmission, and/or activate a living object deterrent. For example, the base charging deterrent system 374 can detect a living object via an object detector 376. In an embodiment, the object detector 376 can include the object detector 142a, described above with respect to FIG. 1. The base charging deterrent system 374 can activate a living object deterrent 378. The living object deterrent 378 can include the living object deterrent 140a (FIG. 1). Accordingly, the base charging deterrent system 374 can activate the living object deterrent 378 as described above with respect to the living object deterrent 140a of FIG. 1. For example, in various embodiments, the base charging deterrent system 374 can activate the living object deterrent 378 when the object detector 376 detects a living object, when the object detector 376 detects a living object during charging, and/or during charging regardless of object detection. The base charging deterrent system 374 can adjust wireless charging (for example, by reducing transmit power, or suspending transmission), for example via the base charging system power converter 336, based on object detection by the object detector 376.

As described above, in some embodiments, the electric vehicle 112 can implement an electric vehicle charging deterrent system 380, in addition or in alternative to the electric vehicle charging deterrent system 374. As shown, the electric vehicle wireless power charging system 314 includes the electric vehicle charging deterrent system 380. The electric vehicle charging deterrent system 380 can be configured to detect a living object, detect a non-living object, characterize a detected object (for example, as living, non-living, human, animal, etc.), adjust a wireless power transmission based on the detected object and/or object characterization, and/or activate a living object deterrent. For example, the electric vehicle deterrent system 380 can detect a living object via an object detector 382. In an embodiment, the object detector 382 can implement functions of the object detector 142a, described above with respect to FIG. 1. The electric vehicle charging deterrent system 380 can activate a living object deterrent 384. The living object deterrent 384 can implement functions of the living object deterrent 140a (FIG. 1). Accordingly, the electric vehicle charging deterrent system 380 can activate the living object deterrent 384 as described above with respect to the living object deterrent 140a of FIG. 1. For example, in various embodiments, the electric vehicle charging deterrent system 380 can activate the living object deterrent 384 when the object detector 382 detects a living object, when the object detector 382 detects a living object during charging, and/or during charging regardless of object detection.

In various embodiments, the base charging deterrent system 374 can communicate and/or control the object detector 382 and/or the living object deterrent 384 via the base charging communication system 372. Likewise, the electric vehicle deterrent system 380 can communicate with and/or control the object detector 376 and/or the living object deterrent 378 via the electric vehicle communication system 374. Accordingly, in various embodiments, the deterrent systems 374 and/or 380 can communicate with one or more object detectors and living object deterrents located remotely. Accordingly, one or more object detectors and living object deterrents can be positioned in any number of locations.

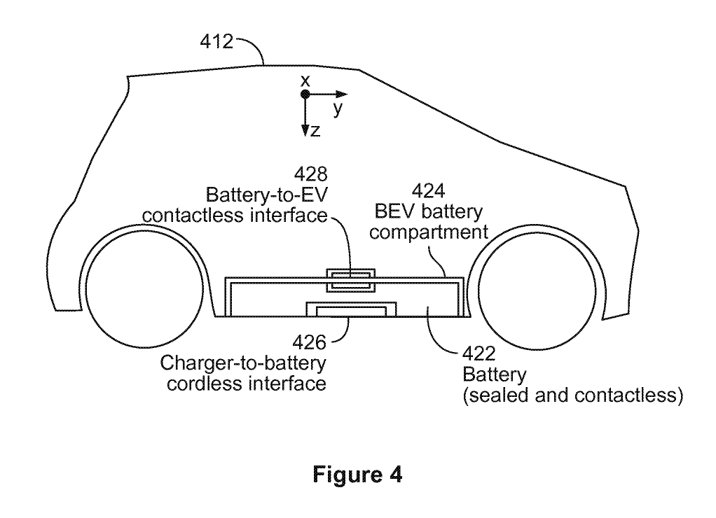

The wireless power transfer system 100 described can be used with a variety of electric vehicles 102 including rechargeable or replaceable batteries. FIG. 4 is a functional block diagram showing a replaceable contactless battery disposed in an electric vehicle 412, in accordance with an exemplary embodiment of the invention. In this embodiment, the low battery position can be useful for an electric vehicle battery unit that integrates a wireless power interface (e.g., a charger-to-battery cordless interface 426) and that can receive power from a charger (not shown) embedded in the ground. In FIG. 4, the electric vehicle battery unit can be a rechargeable battery unit, and can be accommodated in a battery compartment 424. The electric vehicle battery unit also provides a wireless power interface 426, which can integrate the entire electric vehicle wireless power subsystem including a resonant induction coil, power conversion circuitry, and other control and communications functions as needed for efficient and safe wireless energy transfer between a ground-based wireless charging unit and the electric vehicle battery unit.

It can be useful for the electric vehicle induction coil to be integrated flush with a bottom side of electric vehicle battery unit or the vehicle body so that there are no protrusive parts and so that the specified ground-to-vehicle body clearance can be maintained. This configuration can require some room in the electric vehicle battery unit dedicated to the electric vehicle wireless power subsystem. The electric vehicle battery unit 422 can also include a battery-to-EV cordless interface 422, and a charger-to-battery cordless interface 426 that provides contactless power and communication between the electric vehicle 412 and a base wireless charging system 102a as shown in FIG. 1.

In some embodiments, and with reference to FIG. 1, the base system induction coil 104a and the electric vehicle induction coil 116 can be in a fixed position and the induction coils are brought within a near-field coupling region by overall placement of the electric vehicle induction coil 116 relative to the base wireless charging system 102a. However, in order to perform energy transfer rapidly, efficiently, and safely, the distance between the base system induction coil 104a and the electric vehicle induction coil 116 can need to be reduced to improve coupling. Thus, in some embodiments, the base system induction coil 104a and/or the electric vehicle induction coil 116 can be deployable and/or moveable to bring them into better alignment.

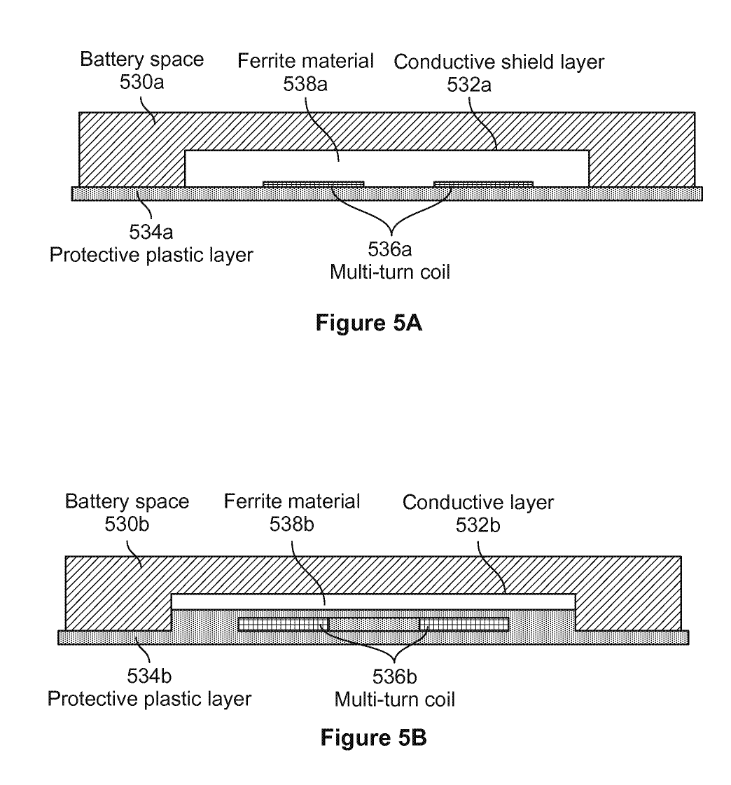

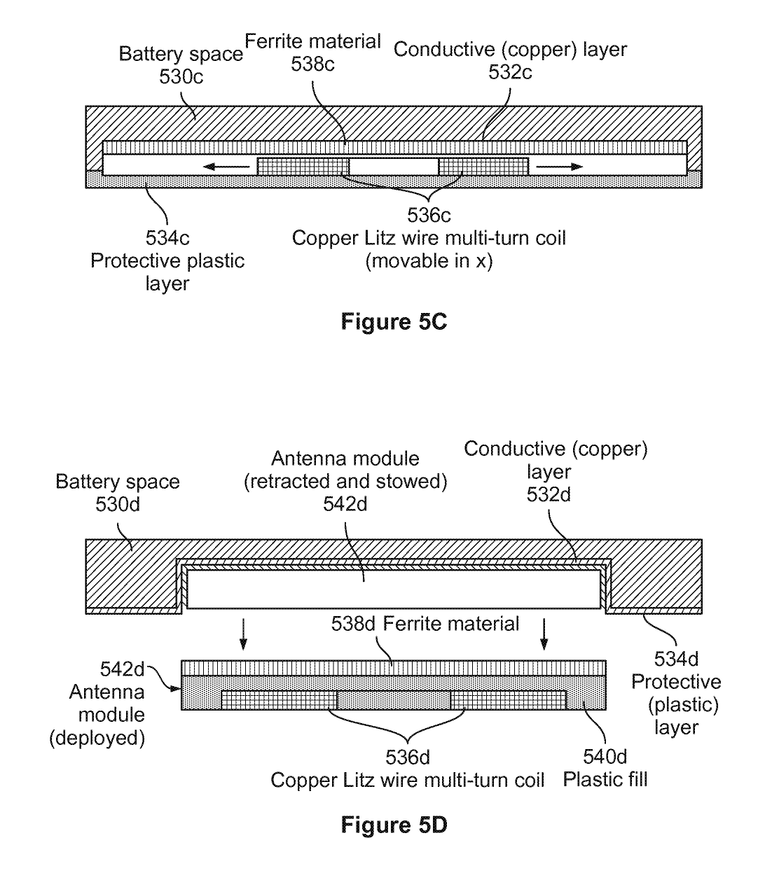

FIGS. 5A, 5B, 5C, and 5D are diagrams of exemplary configurations for the placement of an induction coil and ferrite material relative to a battery, in accordance with exemplary embodiments of the invention. FIG. 5A shows a fully ferrite embedded induction coil 536a. The wireless power induction coil can include a ferrite material 538a and a coil 536a wound about the ferrite material 538a. The coil 536a itself can be made of stranded Litz wire. A conductive shield layer 532a can be provided to protect passengers of the vehicle from excessive EMF transmission. Conductive shielding can be particularly useful in vehicles made of plastic or composites.

FIG. 5B shows an optimally dimensioned ferrite plate (i.e., ferrite backing) to enhance coupling and to reduce eddy currents (heat dissipation) in the conductive shield 532b. The coil 536b can be fully embedded in a non-conducting non-magnetic (e.g., plastic) material. For example, as illustrated in FIG. 5A-5D, the coil 536b can be embedded in a protective housing 534b. There can be a separation between the coil 536b and the ferrite material 538b as the result of a trade-off between magnetic coupling and ferrite hysteresis losses.

FIG. 5C illustrates another embodiment where the coil 536c (e.g., a copper Litz wire multi-turn coil) can be movable in a lateral (“X”) direction. FIG. 5D illustrates another embodiment where the induction coil module is deployed in a downward direction. In some embodiments, the battery unit includes one of a deployable and non-deployable electric vehicle induction coil module 542d as part of the wireless power interface. To prevent magnetic fields from penetrating into the battery space 530d and into the interior of the vehicle, there can be a conductive layer shield 532d (e.g., a copper sheet) between the battery space 530d and the vehicle. Furthermore, a non-conductive (e.g., plastic) protective layer 534d can be used to protect the conductive layer shield 532d, the coil 536d, and the ferrite material 538d from environmental impacts (e.g., mechanical damage, oxidization, etc.). Furthermore, the coil 536d can be movable in lateral X and/or Y directions. FIG. 5D illustrates an embodiment wherein the electric vehicle induction coil module 540d is deployed in a downward Z direction relative to a battery unit body.

The design of this deployable electric vehicle induction coil module 542d is similar to that of FIG. 5B except there is no conductive shielding at the electric vehicle induction coil module 542d. The conductive shield 532d stays with the battery unit body. The protective layer 534d (e.g., plastic layer) is provided between the conductive shield 532d and the electric vehicle induction coil module 542d when the electric vehicle induction coil module 542d is not in a deployed state. The physical separation of the electric vehicle induction coil module 542d from the battery unit body can have a positive effect on the induction coil's performance.

As discussed above, the electric vehicle induction coil module 542d that is deployed can contain only the coil 536d (e.g., Litz wire) and ferrite material 538d. Ferrite backing can be provided to enhance coupling and to prevent from excessive eddy current losses in a vehicle's underbody or in the conductive layer shield 532d. Moreover, the electric vehicle induction coil module 542d can include a flexible wire connection to power conversion electronics and sensor electronics. This wire bundle can be integrated into the mechanical gear for deploying the electric vehicle induction coil module 542d.

With reference to FIG. 1, the charging systems described above can be used in a variety of locations for charging an electric vehicle 112, or transferring power back to a power grid. For example, the transfer of power can occur in a parking lot environment. It is noted that a “parking area” can also be referred to herein as a “parking space.” To enhance the efficiency of a vehicle wireless power transfer system 100, an electric vehicle 112 can be aligned along an X direction and a Y direction to enable an electric vehicle induction coil 116 within the electric vehicle 112 to be adequately aligned with a base wireless charging system 102a within an associated parking area.

Furthermore, the disclosed embodiments are applicable to parking lots having one or more parking spaces or parking areas, wherein at least one parking space within a parking lot can comprise a base wireless charging system 102a. Guidance systems (not shown) can be used to assist a vehicle operator in positioning an electric vehicle 112 in a parking area to align an electric vehicle induction coil 116 within the electric vehicle 112 with a base wireless charging system 102a. Guidance systems can include electronic based approaches (e.g., radio positioning, direction finding principles, and/or optical, quasi-optical and/or ultrasonic sensing methods) or mechanical-based approaches (e.g., vehicle wheel guides, tracks or stops), or any combination thereof, for assisting an electric vehicle operator in positioning an electric vehicle 112 to enable an induction coil 116 within the electric vehicle 112 to be adequately aligned with a charging induction coil within a charging base (e.g., base wireless charging system 102a).

As discussed above, the electric vehicle charging system 114 can be placed on the underside of the electric vehicle 112 for transmitting and receiving power from a base wireless charging system 102a. For example, an electric vehicle induction coil 116 can be integrated into the vehicles underbody preferably near a center position providing maximum safety distance in regards to EM exposure and permitting forward and reverse parking of the electric vehicle.

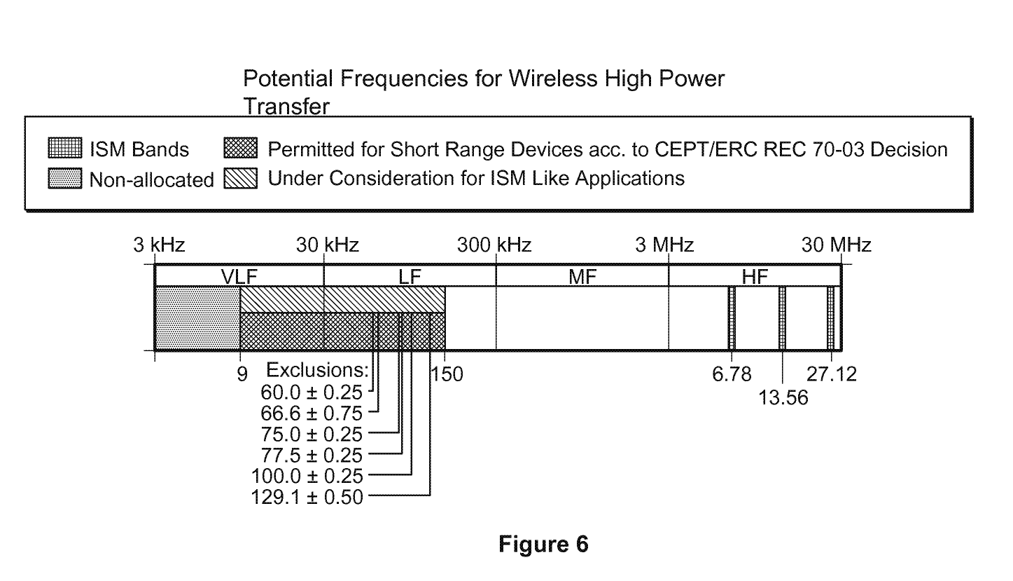

FIG. 6 is a chart of a frequency spectrum showing exemplary frequencies that can be used for wireless charging an electric vehicle, in accordance with an exemplary embodiment of the invention. As shown in FIG. 6, potential frequency ranges for wireless high power transfer to electric vehicles can include: VLF in a 3 kHz to 30 kHz band, lower LF in a 30 kHz to 150 kHz band (for ISM-like applications) with some exclusions, HF 6.78 MHz (ITU-R ISM-Band 6.765-6.795 MHz), HF 13.56 MHz (ITU-R ISM-Band 13.553-13.567), and HF 27.12 MHz (ITU-R ISM-Band 26.957-27.283).

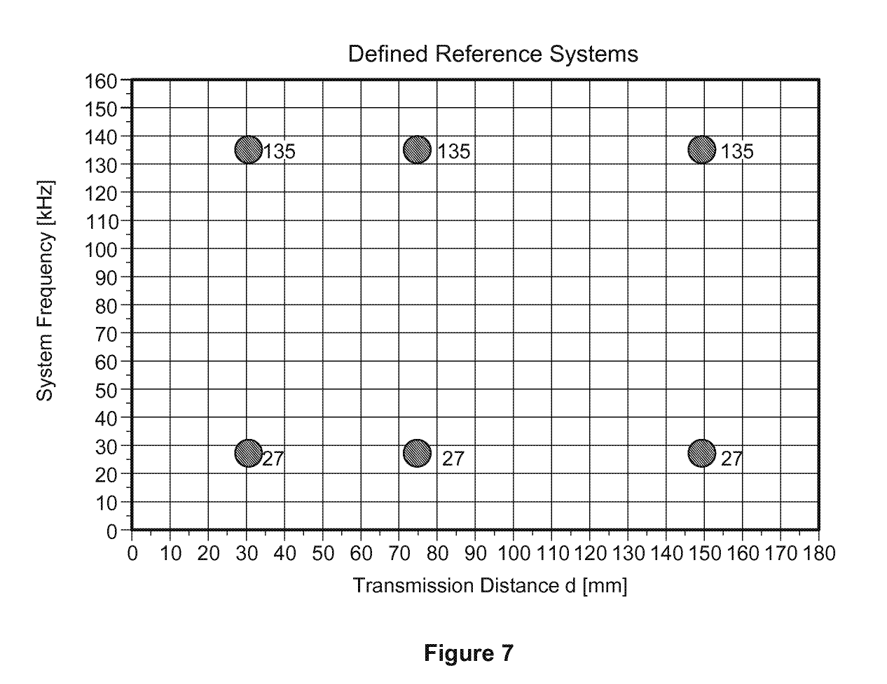

FIG. 7 is a chart showing exemplary frequencies and transmission distances that can be useful in wireless charging electric vehicles, in accordance with an exemplary embodiment of the invention. Some example transmission distances that can be useful for electric vehicle wireless charging are about 30 mm, about 75 mm, and about 150 mm. Some exemplary frequencies can be about 27 kHz in the VLF band and about 135 kHz in the LF band.

During a charging cycle of an electric vehicle, a Base Charging Unit (BCU) of the wireless power transfer system can go through various states of operation. The wireless power transfer system can be referred to as a “charging system.” The BCU can include the base wireless charging system 102a and/or 102b of FIG. 1. The BCU can also include a controller and/or a power conversion unit, such as power converter 236 as illustrated in FIG. 2. Further, the BCU can include one or more base charging pads that include an induction coil, such as induction coils 104a and 104b as illustrated in FIG. 1. As the BCU goes through the various states, the BCU interacts with a charging station. The charging station can include the local distribution center 130, as illustrated in FIG. 1, and can further include a controller, a graphical user interface, a communications module, and a network connection to a remote server or group of servers.

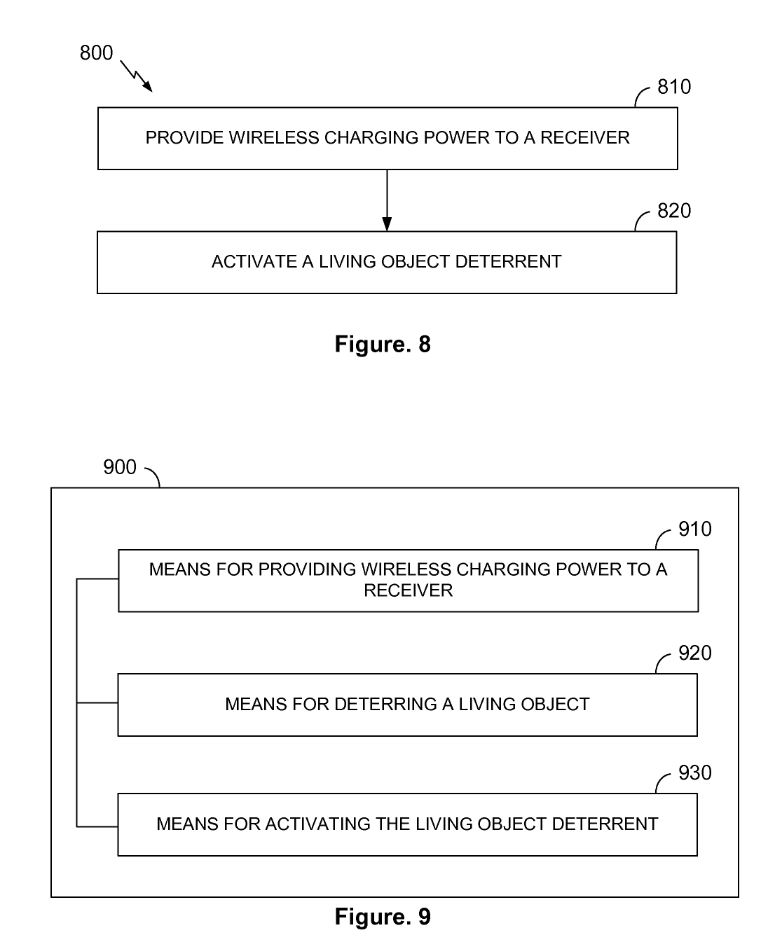

FIG. 8 illustrates a flowchart 800 of an exemplary method of wireless power transfer. Although the method of flowchart 800 is described herein with reference to the base wireless charging system 302 discussed above with respect to FIG. 3, a person having ordinary skill in the art will appreciate that the method of flowchart 800 can be implemented by another device described herein, or any other suitable device. In an embodiment, the steps in flowchart 800 can be performed by a processor or controller such as, for example, the controllers 374 (FIG. 3), and/or 342 (FIG. 3). Although the method of flowchart 800 is described herein with reference to a particular order, in various embodiments, blocks herein can be performed in a different order, or omitted, and additional blocks can be added.

First, at block 810, the base wireless charging system 302 provides wireless charging power to a receiver. For example, the base charging system power converter 336 can provide power to electric vehicle induction coil 316 via the base system induction coil 304. The electric vehicle charging system 314 can receive wireless charging power from the base system induction coil 304 via the electric vehicle induction coil 316

Next, at block 820, the base wireless charging system 302 activates a living object deterrent. For example, the base charging deterrent system 374 can activate the living object deterrent 378. In various other embodiments, the base charging deterrent system 374 can activate the living object deterrent 384 via the base charging communication system 372, the electric vehicle deterrent system 380 can activate the living object deterrent 384, and/or the electric vehicle deterrent system 380 can activate the living object deterrent 378 via the electric vehicle communication system 374.

In some embodiments, activating a living object deterrent can include emitting at least one sonic frequency. For example, the living object deterrent 378 can include a sonic emitter, as described above with respect to the living object deterrent 140a of FIG. 1. At least one sonic frequency can be ultrasonic. The living object deterrent 378 can additionally or alternatively include flashing or continuous lights.

In an embodiment, the base charging deterrent system 374 can detect a non-charging object. The base charging deterrent system 374 can activate the living object deterrent 378 and/or 384 based on the detection of the non-charging object. In an embodiment, detecting the non-charging object can include detecting a living object. In an embodiment, the electric vehicle deterrent system 380 can detect the non-charging object and/or activate the living object deterrent 378 and/or 384 based on the detection of the non-charging object.

In various embodiments, the base charging system controller 342 and/or the electric vehicle controller 344 can adjust a characteristic of the wireless power transfer based on the detection of the non-charging object. For example, the base charging system controller 342 can cause the base charging system power converter 336 to reduce or terminate transmission. In an embodiment, the electric vehicle controller 342 can cause the base charging system power converter 336 to reduce or terminate transmission via the electric vehicle communication system 374.

Moreover, the base charging deterrent system 374 and/or the electric vehicle deterrent system 380 can detect the absence of the non-charging object and adjust a characteristic of the wireless power transfer based on the detected absence. For example, the base charging system controller 342 can cause the base charging system power converter 336 to increase or restart transmission. In an embodiment, the electric vehicle controller 342 can cause the base charging system power converter 336 to increase or restart transmission via the electric vehicle communication system 374.

In some embodiments, the base charging deterrent system 374 and/or the electric vehicle deterrent system 380 can activate the living object deterrent 378 and/or 384 periodically, intermittently, and/or continuously while providing wireless charging power to the receiver.

FIG. 9 is a functional block diagram of a wireless power apparatus 900, in accordance with an exemplary embodiment of the invention. Those skilled in the art will appreciate that a wireless power apparatus can have more components than the simplified wireless communication device 900 shown in FIG. 9. The wireless power apparatus 900 shown includes only those components useful for describing some prominent features of implementations within the scope of the claims. The wireless power apparatus 900 includes means 910 for providing wireless charging power to a receiver, means 920 for deterring a living object, and means 930 for activating the living object deterrent.

In an embodiment, the means 910 for providing wireless charging power to a receiver can be configured to perform one or more of the functions described above with respect to block 810 (FIG. 8). In various embodiments, the means 910 for providing wireless charging power to a receiver can be implemented by one or more of the base wireless charging system 102a and/or 102b (FIG. 1), the base system induction coil 104a and/or 104b (FIG. 1), the wireless power transfer system 200 (FIG. 2), the base wireless charging system 302 (FIG. 3), the base charging system controller 342 (FIG. 3), the base charging system power converter 336 (FIG. 3), the base charging system power interface 360 (FIG. 3), and/or the base system induction coil 304 (FIG. 3).

The means 920 for deterring a living object can be configured to perform one or more of the functions described above with respect to block 820 (FIG. 8). In various embodiments, the means 920 for deterring a living object can be implemented by can be implemented by one or more of the living object deterrent 140a and/or 140b (FIG. 1) and/or the living object deterrent 378 and/or 384 (FIG. 3).

The means 930 for activating the living object deterrent can be configured to perform one or more of the functions described above with respect to block 820 (FIG. 8). In various embodiments, the means 930 for activating the living object deterrent can be implemented by a processor or controller such as, for example, the base wireless charging system 102a and/or 102b (FIG. 1), the base charging system controller 342 (FIG. 3), the electric vehicle controller 344 (FIG. 3), the base charging deterrent system 374 (FIG. 3), and/or the electric vehicle deterrent system 380 (FIG. 3).

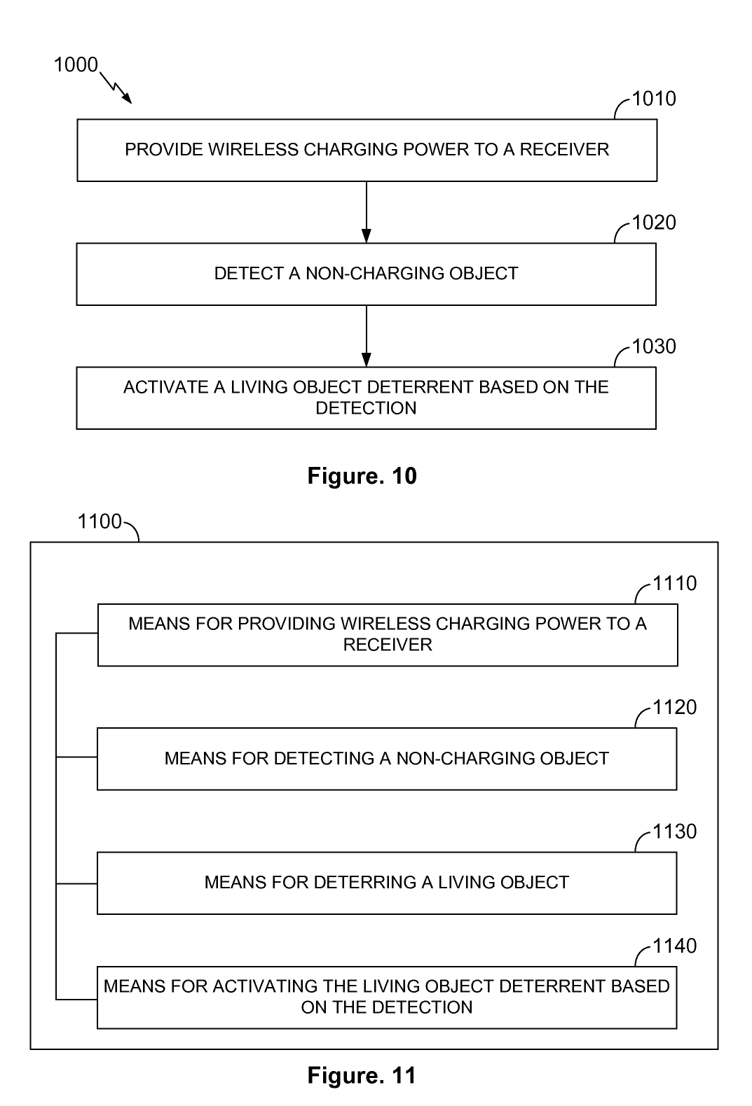

FIG. 10 illustrates a flowchart 1000 of an exemplary method of wireless power transfer. Although the method of flowchart 1000 is described herein with reference to the base wireless charging system 302 discussed above with respect to FIG. 3, a person having ordinary skill in the art will appreciate that the method of flowchart 1000 can be implemented by another device described herein, or any other suitable device. In an embodiment, the steps in flowchart 1000 can be performed by a processor or controller such as, for example, the controllers 374 (FIG. 3), and/or 342 (FIG. 3). Although the method of flowchart 1000 is described herein with reference to a particular order, in various embodiments, blocks herein can be performed in a different order, or omitted, and additional blocks can be added.

First, at block 1010, the base wireless charging system 302 provides wireless charging power to a receiver. For example, the base charging system power converter 336 can provide power to electric vehicle induction coil 316 via the base system induction coil 304. The electric vehicle charging system 314 can receive wireless charging power from the base system induction coil 304 via the electric vehicle induction coil 316

Next, at block 1020, the base wireless charging system 302 detects a non-charging object. For example, the base charging deterrent system 374 can detect a living object via the object detector 376. In an embodiment, detecting the non-charging object can include detecting a living object. In an embodiment, the electric vehicle deterrent system 380 can detect the non-charging object based on the detection of the non-charging object. In an embodiment, the object detector 376 detects an object and characterizes the object (for example, as living or non-living, as discussed above with respect to the object detectors 142a and 142b of FIG. 1).

Then, at block 1030, the base wireless charging system 302 activates a living object deterrent based on the detection. For example, the base charging deterrent system 374 can activate the living object deterrent 378. In various other embodiments, the base charging deterrent system 374 can activate the living object deterrent 384 via the base charging communication system 372, the electric vehicle deterrent system 380 can activate the living object deterrent 384, and/or the electric vehicle deterrent system 380 can activate the living object deterrent 378 via the electric vehicle communication system 374.

In some embodiments, activating a living object deterrent can include emitting at least one sonic frequency. For example, the living object deterrent 378 can include a sonic emitter, as described above with respect to the living object deterrent 140a of FIG. 1. The at least one sonic frequency can be ultrasonic. The living object deterrent 378 can additionally or alternatively include flashing or continuous lights.

In various embodiments, the base charging system controller 342 and/or the electric vehicle controller 344 can adjust a characteristic of the wireless power transfer based on the detection of the non-charging object. For example, the base charging system controller 342 can cause the base charging system power converter 336 to reduce or terminate transmission. In an embodiment, the electric vehicle controller 342 can cause the base charging system power converter 336 to reduce or terminate transmission via the electric vehicle communication system 374.

In an embodiment, activating a living object deterrent can be based on the characterization of the detected object. For example, the base charging deterrent system 374 may only activate the living object deterrent 378 when the object detector 376 characterizes a detected object as living and/or animal. In an embodiment, the base charging deterrent system 374 can reduce or terminate power transmission based on the object characterization. For example, the base charging deterrent system 374 can reduce or terminate power transmission without activating the living object deterrent 378 when the object detector 376 characterizes a detected object as non-living and/or insect.

Moreover, the base charging deterrent system 374 and/or the electric vehicle deterrent system 380 can detect the absence of the non-charging object and adjust a characteristic of the wireless power transfer based on the detected absence. For example, the base charging system controller 342 can cause the base charging system power converter 336 to increase or restart transmission. In an embodiment, the electric vehicle controller 344 can cause the base charging system power converter 336 to increase or restart transmission via the electric vehicle communication system 374.

In some embodiments, the base charging deterrent system 374 and/or the electric vehicle deterrent system 380 can activate the living object deterrent 378 and/or 384 periodically, intermittently, and/or continuously while providing wireless charging power to the receiver.

FIG. 11 is a functional block diagram of a wireless power apparatus 1100, in accordance with an exemplary embodiment of the invention. Those skilled in the art will appreciate that a wireless power apparatus can have more components than the simplified wireless communication device 1100 shown in FIG. 11. The wireless power apparatus 1100-shown includes only those components useful for describing some prominent features of implementations within the scope of the claims. The wireless power apparatus 1100 includes means 1110 for providing wireless charging power to a receiver, means 1120 for detecting a non-charging object, means 1130 for deterring a living object, and means 1140 for activating the living object deterrent based on the detection.

In an embodiment, the means 1110 for providing wireless charging power to a receiver can be configured to perform one or more of the functions described above with respect to block 1010 (FIG. 10). In various embodiments, the means 1110 for providing wireless charging power to a receiver can be implemented by one or more of the base wireless charging system 102a and/or 102b (FIG. 1), the base system induction coil 104a and/or 104b (FIG. 1), the wireless power transfer system 200 (FIG. 2), the base wireless charging system 302 (FIG. 3), the base charging system controller 342 (FIG. 3), the base charging system power converter 336 (FIG. 3), the base charging system power interface 360 (FIG. 3), and/or the base system induction coil 304 (FIG. 3).

The means 1120 for detecting a non-charging object can be configured to perform one or more of the functions described above with respect to block 1020 (FIG. 10). In various embodiments, the means 1120 for detecting a non-charging object can be implemented by one or more of the base wireless charging system 102a and/or 102b (FIG. 1), the object detector 142a and/or 142b (FIG. 1), the object detector 376 and/or 382 (FIG. 3), the base charging deterrent system 374 (FIG. 3), and/or the electric vehicle deterrent system 380 (FIG. 3).

The means 1130 for deterring a living object can be configured to perform one or more of the functions described above with respect to block 1030 (FIG. 10). In various embodiments, the means 1130 for deterring a living object can be implemented by can be implemented by one or more of the living object deterrent 140a and/or 140b (FIG. 1) and/or the living object deterrent 378 and/or 384 (FIG. 3).

The means 1140 for activating the living object deterrent can be configured to perform one or more of the functions described above with respect to block 1030 (FIG. 10). In various embodiments, the means 1140 for activating the living object deterrent can be implemented by a processor or controller such as, for example, the base wireless charging system 102a and/or 102b (FIG. 1), the base charging system controller 342 (FIG. 3), the electric vehicle controller 344 (FIG. 3), the base charging deterrent system 374 (FIG. 3), and/or the electric vehicle deterrent system 380 (FIG. 3).

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

Information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the embodiments of the invention.

The various illustrative blocks, modules, and circuits described in connection with the embodiments disclosed herein can be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein can be embodied directly in hardware, in a software module executed by a processor, or in a combination of the two. If implemented in software, the functions can be stored on or transmitted over as one or more instructions or code on a tangible, non-transitory computer-readable medium. A software module can reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium can be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium can reside in an ASIC. The ASIC can reside in a user terminal. In the alternative, the processor and the storage medium can reside as discrete components in a user terminal.

For purposes of summarizing the disclosure, certain aspects, advantages and novel features of the inventions have been described herein. It is to be understood that not necessarily all such advantages can be achieved in accordance with any particular embodiment of the invention. Thus, the invention can be embodied or carried out in a manner that achieves or optimizes one advantage or group of advantages as taught herein without necessarily achieving other advantages as can be taught or suggested herein.

Various modifications of the above described embodiments will be readily apparent, and the generic principles defined herein can be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of wireless power transfer comprising:
providing wireless charging power to a receiver; and
activating a living object deterrent.

2. The method of claim 1, wherein activating a living object deterrent comprises emitting at least one sonic frequency.

3. The method of claim 2, wherein the at least one sonic frequency is ultrasonic.

4. The method of claim 1, further comprising detecting a non-charging object, wherein said activating the living object deterrent is based on said detecting.

5. The method of claim 4, further comprising adjusting a characteristic of the wireless power transfer based on said detecting.

6. The method of claim 5, wherein adjusting the characteristic of wireless power transfer comprises ceasing the wireless power transfer when the non-charging object is detected.

7. The method of claim 5, further comprising detecting the absence of the non-charging object and adjusting a characteristic of the wireless power transfer based on the detected absence.

8. The method of claim 5, further comprising characterizing the detected object, wherein said activating the living object deterrent and/or adjusting a characteristic of the wireless power transfer is based on the object characterization.

9. The method of claim 1, wherein said activating the living object deterrent comprises periodically, intermittently, and/or continuously activating the living object deterrent while providing wireless charging power to the receiver.

10. The method of claim 1, wherein the living object deterrent comprises flashing or continuous lights.

11. A method of wireless power transfer comprising:
providing wireless charging power to a receiver;
detecting a non-charging object; and
activating a living object deterrent based on said detecting.

12. A device configured to provide wireless power comprising:
a transmitter configured to provide wireless charging power to a receiver;
a living object deterrent; and
a controller configured to activate the living object deterrent.

13. The device of claim 12, wherein the living object deterrent is configured to emit at least one sonic frequency.

14. The device of claim 13, wherein the at least one sonic frequency is ultrasonic.

15. The device of claim 12, further comprising an object detector configured to detect a non-charging object, wherein the controller is configured to activate the living object deterrent based on said detecting.

16. The device of claim 15, wherein the controller is further configured to adjust a characteristic of the wireless power transfer based on said detecting.

17. The device of claim 16, wherein adjusting the characteristic of wireless power transfer comprises ceasing the wireless power transfer when the non-charging object is detected.

18. The device of claim 16, wherein the object detector is further configured to detect the absence of the non-charging object and the controller is further configured to adjust a characteristic of the wireless power transfer based on the detected absence.

19. The device of claim 16, wherein the object detector is further configured to characterize the detected object and activate the living object deterrent and/or adjust a characteristic of the wireless power transfer based on the object characterization.

20. The device of claim 12, wherein the controller is configured to activate the living object deterrent periodically, intermittently, and/or continuously while the transmitter provides wireless charging power to the receiver.

21. The device of claim 1, wherein the living object deterrent comprises flashing or continuous lights.

22. A device configured to provide wireless power comprising:
a transmitter configured to provide wireless charging power to a receiver;
an object detector configured to detect a non-charging object; and
a living object deterrent; and
a controller configured to activate the living object deterrent based on the detection.

23. An apparatus for wireless power transfer comprising:
means for providing wireless charging power to a receiver;
means for deterring a living object; and
means for activating the living object deterrent.

24. The apparatus of claim 23, wherein means for deterring a living object comprises means for emitting at least one sonic frequency.

25. The apparatus of claim 24, wherein the at least one sonic frequency is ultrasonic.

26. The apparatus of claim 23, further comprising means for detecting a non-charging object, wherein said means for activating the living object deterrent is based on said detecting.

27. The apparatus of claim 26, further comprising means for adjusting a characteristic of the wireless power transfer based on said detecting.

28. The apparatus of claim 27, wherein means for adjusting the characteristic of wireless power transfer comprises means for ceasing the wireless power transfer when the non-charging object is detected.

29. The apparatus of claim 27, further comprising means for detecting the absence of the non-charging object and means for adjusting a characteristic of the wireless power transfer based on the detected absence.

30. The apparatus of claim 27, further comprising means for characterizing the detected object, and means for activating the living object deterrent and/or adjusting a characteristic of the wireless power transfer based on the object characterization.

31. The apparatus of claim 23, wherein said means for activating the living object deterrent comprises means for periodically, intermittently, and/or continuously activating the living object deterrent while providing wireless charging power to the receiver.

32. The apparatus of claim 23, wherein means for deterring a living object comprises flashing or continuous lights.

33. An apparatus for wireless power transfer comprising:
means for providing wireless charging power to a receiver;
means for detecting a non-charging object;
means for deterring a living object; and
means for activating a living object deterrent based on said detecting.

34. A non-transitory computer-readable medium comprising code that, when executed, causes an apparatus to:
provide wireless charging power to a receiver; and
activate a living object deterrent.

35. The medium of claim 34, wherein activating a living object deterrent comprises emitting at least one sonic frequency.

36. The medium of claim 35, wherein the at least one sonic frequency is ultrasonic.

37. The medium of claim 34, further comprising code that, when executed, causes the apparatus to detect a non-charging object, wherein said activating the living object deterrent is based on said detecting.

38. The medium of claim 37, further comprising code that, when executed, causes the apparatus to adjust a characteristic of the wireless power transfer based on said detecting.

39. The medium of claim 38, wherein adjusting the characteristic of wireless power transfer comprises ceasing the wireless power transfer when the non-charging object is detected.

40. The medium of claim 38, further comprising code that, when executed, causes the apparatus to detect the absence of the non-charging object and adjusting a characteristic of the wireless power transfer based on the detected absence.

41. The medium of claim 38, further comprising code that, when executed, causes the apparatus to characterize the detected object, and activate the living object deterrent and/or adjust a characteristic of the wireless power transfer based on the object characterization.

42. The medium of claim 34, wherein said activating the living object deterrent comprises periodically, intermittently, and/or continuously activating the living object deterrent while providing wireless charging power to the receiver.

43. The medium of claim 34, wherein the living object deterrent comprises flashing or continuous lights.

44. A non-transitory computer-readable medium comprising code that, when executed, causes an apparatus to:
provide wireless charging power to a receiver;
detect a non-charging object; and
activate a living object deterrent based on said detecting.
